(19) United States
(12) Patent Application Publication
(10) Pub. No.: US 2025/0266672 A1
(43) Pub. Date: Aug. 21, 2025

(54) Assembly for connection of two superconductive cables

(71) Applicant: NEXANS, Courbevoie (FR)

(72) Inventors: Nicolas LALLOUET, BAINCTHUN (FR); Loïc LEGRAND, AUDRUICQ (FR); Sébastien DELPLACE, LOON-PLAGE (FR)

(21) Appl. No.: 19/032,689

(22) Filed: Jan. 21, 2025

(30) Foreign Application Priority Data
Feb. 6, 2024 (FR) 2401126

(51) Int. Cl. H02G 15/34; H01R 4/68

(52) U.S. Cl. CPC H02G 15/34; H01R 4/68

(57) ABSTRACT

A superconductive cable installation includes at least one jointing pit (F) in which arrive superconductive cables (C1, C2), each superconductive cable (C1, C2) having a cable core surrounded by a cryogenic envelope (Cr1, Cr2) and at least one connection assembly (100) situated in the jointing pit (F) in such a manner as to connect two of the superconductive cables to produce a transmission link. The assembly has a jointing device (50) with two connection ports (P1, P2), each connection port being configured to receive the cable core of a respective one of the two superconductive cables (C1, C2). Two compensation devices (22a, 22b) are configured to absorb a variation in length of the cable core of a respective one of the superconductive cables caused by a variation in temperature for passage to the superconductive state. Each compensation device has an inlet end (Ee) configured to receive the cable core and an outlet end (Es) connected to a respective one of the connection ports in such a manner as to deliver the cable core to the jointing device.

### RELATED APPLICATION

The present application claims the benefit of priority from French Patent Application No. 22 01126, filed on Feb. 6, 2024, the entirety of which is incorporated by reference.

### TECHNICAL FIELD

The present invention concerns a connection assembly configured to connect two superconductive cables. The invention further concerns a superconductive cable installation comprising an assembly according to the invention.

The invention applies typically but not exclusively to superconductive cables intended to transport electrical energy, in particular electrical connections at low voltage, or at medium voltage (in particular from 6 to 45-60 kV), or high voltage (in particular greater than 60 kV, and possibly up to 400 kV, for example), both direct current and alternating current, in various fields such as those of overhead, submarine, terrestrial electricity transport, or the aeronautical field, or the rail transport field.

In particular superconductive cables enable transportation of electrical currents, in particular high electrical currents, with cable sections much smaller than those of conventional transport cables consisting of resistive electrical conductors, while limiting electrical losses along the cable, in particular Joule effect losses, since this phenomenon does not exist in the superconductive state.

### OBJECTS AND SUMMARY

A so-called “cold dielectric” superconductive cable generally comprises a cable core including at least one superconducting central part, a dielectric layer surrounding the superconducting part, and shielding surrounding said dielectric layer and possibly consisting in whole or in part of superconductors. The superconductive cable further comprises a cryogenic enclosure or cryostat surrounding said cable core. The cryostat typically comprises two concentric envelopes thermally insulated from one another by a 10⁻⁵ mbar vacuum for example. A cryogenic fluid contained inside the internal envelope of the cryostat cools the cable core, in particular via the dielectric layer, whence the term “cold dielectric”, until a temperature is reached at which the superconductor is in a superconductive state. This temperature is for example of the order of minus 200° C. for so-called “high-temperature” superconductors. Also known are so-called “hot dielectric” superconductive cables in which the superconducting part is included in a hollow element, generally a tube, in which a cryogenic fluid circulates. In this case the dielectric layer is applied over this tube, which may be thermally insulated, hence the term “hot dielectric”.

Furthermore, to obtain a transmission link of great length (several kilometres or tens of kilometres) it is necessary to connect successive superconductive cables. In fact, superconductive cables are manufactured in finite unit lengths defined by their capacity for transportation on a cable drum. This unit length depends specifically on the cable design chosen but is usually between a few hundred metres and 1 to 2 kilometres. Each superconductive cable is generally installed in a duct that opens into a jointing pit in which the superconductive cable is connected to the next superconductive cable.

The cable core shortens significantly during cooling to achieve the superconductive state. Thus it is estimated that its length varies by approximately 0.3%. For example, a cable distance of 800 m causes shortening of the cable core that can be up to 2.4 m.

One solution for managing the reduction of the length of the cable core during cooling of superconductive cables is known from the published patent application US 2019/0260194 A1. That document describes a compensation device comprising a cryogenic envelope of curved shape with a large radius of curvature. At ambient temperature the cable core is located at the level of the portion of the internal wall of the cryogenic envelope having the highest radius of curvature. During cooling the cable core shortens and moves toward the portion of the internal wall of the cryogenic envelope that has the lowest radius of curvature. The advantage of this compensation device is that no external force is applied to the cable core. It moves of its own accord in a controlled space.

However, integration of the compensation device requires additional space in superconductive cable systems. The longer the superconductive cable the greater the required radius of curvature of the compensation device. In a transmission link comprising a plurality of interconnected superconductive cables the overall size linked to the integration of the compensation device or devices is even more difficult to manage.

Thus there exists a need, with a limited overall size, to manage shortening due to the cooling necessary to obtain the superconductive state in a transmission link comprising a plurality of superconductive cables connected in series.

### SUMMARY OF THE INVENTION

To this end the invention proposes a superconductive cable installation comprising at least one jointing pit in which arrive superconductive cables, each superconductive cable comprising a cable core surrounded by a cryogenic envelope and at least one connection assembly situated in said jointing pit in such a manner as to connect two of said superconductive cables to produce a transmission link, said connection assembly comprising:
a jointing device comprising two connection ports, each connection port being configured to receive the cable core of a respective one of the two superconductive cables, and
two compensation devices configured to absorb a variation in length of the cable core of a respective one of said superconductive cables caused by a variation in temperature for passage to the superconductive state,
each compensation device comprising an inlet end configured to receive the cable core and an outlet end connected to a respective one of said connection ports in such a manner as to deliver the cable core to the jointing device.

The invention further concerns a connection assembly configured to connect two superconductive cables in such a manner as to produce a transmission link, each superconductive cable comprising a cable core surrounded by a cryogenic envelope, said assembly comprising:
a jointing device comprising two connection ports, each connection port being configured to receive the cable core of a respective one of the two superconductive cables, and
two compensation devices configured to absorb a variation in length of the cable core of a respective one of said superconductive cables caused by a variation in temperature for passage to the superconductive state,
   each compensation device comprising an inlet end configured to receive the cable core and an outlet end connected to a respective one of said connection ports in such a manner as to deliver the cable core to the jointing device.

By providing a compensation device on either side of the jointing device the shortening due to the cooling to obtain the superconductive state is managed at the level of each cable. By associating the compensation devices and the jointing device the latter may be provided in the same space, which facilitates their integration into the superconductive cable system.

In accordance with one embodiment the connection ports of the jointing device are situated at opposite ends of the jointing device.

In accordance with one embodiment the connection ports of the jointing device are situated at the same end of the jointing device.

In accordance with one embodiment each compensation device includes an interior tube and an exterior tube that are coaxial and between which vacuum insulation is provided, the interior tube being configured to receive the core of the respective superconductive cable and a cooling fluid intended to cool said core to a cooling temperature for a superconductive state;
said interior and exterior tubes utilizing at least one curvature by an angle greater than or equal to 90° and the dimensions of the interior and exterior tubes being configured so that, in said curvature:
   at ambient temperature the cable core is in the proximity of a portion of the internal wall of the interior tube having the highest radius of curvature, and
   at cooling temperature the cable core is in the proximity of a portion of the internal wall of the interior tube having a lowest radius of curvature.

In accordance with a variant the curvatures of the compensation devices are accommodated in a space delimited by a side of the jointing device and/or arranged so that their axes are parallel to one another.

In accordance with a variant the curvatures are situated substantially face-to-face in a longitudinal direction of the jointing device.

In accordance with a variant the axes of the curvatures are perpendicular or parallel to a central transverse plane common to the connection ports of the jointing device.

In accordance with a variant the curvatures of the compensation devices are on respective opposite sides of a median plane of the jointing device, and the axes of the curvatures are parallel to a transverse plane common to the connection ports of the jointing device.

In accordance with a variant one of said compensation devices utilizes a curvature of 360°, this compensation device having an outlet end oriented toward the same side as the corresponding connection port of the jointing device, said outlet end of said compensation device being connected to the respective port via a compensation element of U-shape.

In accordance with a variant the curvatures of the compensation devices utilize angles of 180° and have an angular offset between them in such a manner as to allow to pass the cables connected to the compensation devices.

The invention further concerns a superconductive cable installation comprising at least one jointing pit in which superconductive cables arrive and at least one connection assembly according to the invention situated in said jointing pit in such a manner as to connect two of said superconductive cables.

In accordance with one embodiment the superconductive cable installation comprises a plurality of connection assemblies situated in said jointing pit in such a manner as to connect a respective pair of said superconductive cables.

In accordance with a variant the jointing devices are aligned in the same longitudinal direction and the curvatures are face-to-face in said longitudinal direction or in a direction perpendicular to said longitudinal direction.

In accordance with one embodiment the installation comprises at least two jointing pits in which the superconductive cables arrive, each jointing pit comprising at least one connection assembly in such a manner as to connect a respective pair of said superconductive cables, one of the cables of the pair crossing the other jointing pit.

In accordance with one embodiment the superconductive cables connected to the at least one connection assembly comprise a first end connected to said connection assembly and a second end connected to a compensation device.

The invention also concerns a superconductive cable installation comprising a plurality of connection assemblies according to the invention connecting in series a plurality of cables of a transmission link.

The invention also concerns a superconductive cable installation comprising at least one jointing pit in which arrive superconductive cables, each superconductive cable comprising a cable core surrounded by a cryogenic envelope, and a plurality of connection assemblies situated in said jointing pit in such a manner as to connect a respective pair of said superconductive cables, each connection assembly comprising:
a jointing device comprising two connection ports, each connection port being configured to receive the core of a respective cable of the pair of superconductive cables, and
at least one compensation device configured to absorb a variation in length of the core of a first cable of the pair of superconductive cables caused by a variation in temperature for passage to the superconductive state, the compensation device comprising an inlet end configured to receive the core of the first cable and an outlet end connected to one of said connection ports in such a manner as to deliver the core of the first cable to the jointing device, the compensation device including an interior tube and an exterior tube that are coaxial and between which vacuum insulation is provided, the interior tube being configured to receive the core of the first superconductive cable and a cooling fluid intended to cool said core to a cooling temperature for a superconductive state, said interior and exterior tubes utilizing at least one curvature by an angle greater than or equal to 90°,
   in which installation the axes of the curvatures of the compensation devices are parallel to one another.

The invention also concerns a connection assembly configured to connect two superconductive cables in such a manner as to produce a transmission link, each superconductive cable comprising a cable core surrounded by a cryogenic envelope, said assembly comprising:
a jointing device comprising two connection ports, each connection port being configured to receive the cable core of a respective one of the two superconductive cables, and
at least one compensation device configured to absorb a variation in length of the core of a first cable of the pair of superconductive cables caused by a variation in temperature for passage to the superconductive state,
   the compensation device comprising an inlet end configured to receive the core of the first cable and an outlet end connected to one of said connection ports in such a manner as to deliver the core of the first cable to the jointing device, the compensation device including an interior tube and an exterior tube that are coaxial and between which vacuum insulation is provided, the interior tube being configured to receive the core of the first superconductive cable and a cooling fluid intended to cool said core to a cooling temperature for a superconductive state, said interior and exterior tubes having a curvature by an angle equal to 90°.

### BRIEF DESCRIPTION OF THE FIGURES

The following description with regard to the appended drawings, provided by way of non-limiting example, will make it clear in what the invention consists and how it may be implemented. In the appended figures:

FIG. 1 represents diagrammatically a view of a first example of a connection assembly;

FIG. 2 represents diagrammatically a view of the first example of a connection assembly;

FIG. 3 represents diagrammatically a view of the first example of a connection assembly;

FIG. 4 represents diagrammatically one example of a jointing device;

FIG. 5 represents diagrammatically another example of a jointing device;

FIG. 6 represents diagrammatically one example of a compensation device;

FIG. 7 represents diagrammatically one example of a compensation device;

FIG. 8 represents diagrammatically one example of a compensation device;

FIG. 9 is a diagram explaining one example of a compensation device;

FIG. 10 is a diagram explaining one example of a jointing device;

FIG. 11 represents diagrammatically a view of a second example of a connection assembly;

FIG. 12 represents diagrammatically a view of the second example of a connection assembly;

FIG. 13 represents diagrammatically a view of the second example of a connection assembly;

FIG. 14 represents diagrammatically a view of a third example of a connection assembly;

FIG. 15 represents diagrammatically a view of the third example of a connection assembly;

FIG. 16 represents diagrammatically a view of a fourth example of a connection assembly;

FIG. 17 represents diagrammatically a view of the fourth example of a connection assembly;

FIG. 18 represents diagrammatically a view of a fifth example of a connection assembly;

FIG. 19 represents diagrammatically a view of the fifth example of a connection assembly;

FIG. 20 represents diagrammatically a view of the fifth example of a connection assembly;

FIG. 21 represents diagrammatically a view of a sixth example of a connection assembly;

FIG. 22 represents diagrammatically a view of the sixth example of a connection assembly;

FIG. 23 represents diagrammatically a view of the sixth example of a connection assembly;

FIG. 24 represents diagrammatically a view of a seventh example of a connection assembly;

FIG. 25 represents diagrammatically a view of the seventh example of a connection assembly;

FIG. 26 represents diagrammatically a view of an eighth example of a connection assembly;

FIG. 27 represents diagrammatically a view of the eighth example of a connection assembly;

FIG. 28 represents diagrammatically a view of the eighth example of a connection assembly;

FIG. 29 is a diagram explaining one example of a connection assembly;

FIG. 30 represents diagrammatically a view of a ninth example of a connection assembly;

FIG. 31 represents diagrammatically a view of the ninth example of a connection assembly;

FIG. 32 represents diagrammatically a view of another example of a connection assembly;

FIG. 33 represents diagrammatically a view of it from above of one example of an installation;

FIG. 34 represents diagrammatically a side view of the FIG. 33 example of an installation;

FIG. 35 represents diagrammatically a side view of one example of an installation;

FIG. 36 represents diagrammatically a view of it from above of the FIG. 35 example of an installation;

FIG. 37 represents diagrammatically a side view of one example of an installation;

FIG. 38 represents diagrammatically a view of it from above of the FIG. 38 example of an installation;

FIG. 39 represents diagrammatically a side view of one example of an installation;

FIG. 40 represents diagrammatically a view of it from above of the FIG. 39 example of an installation.

### DETAILED DESCRIPTION

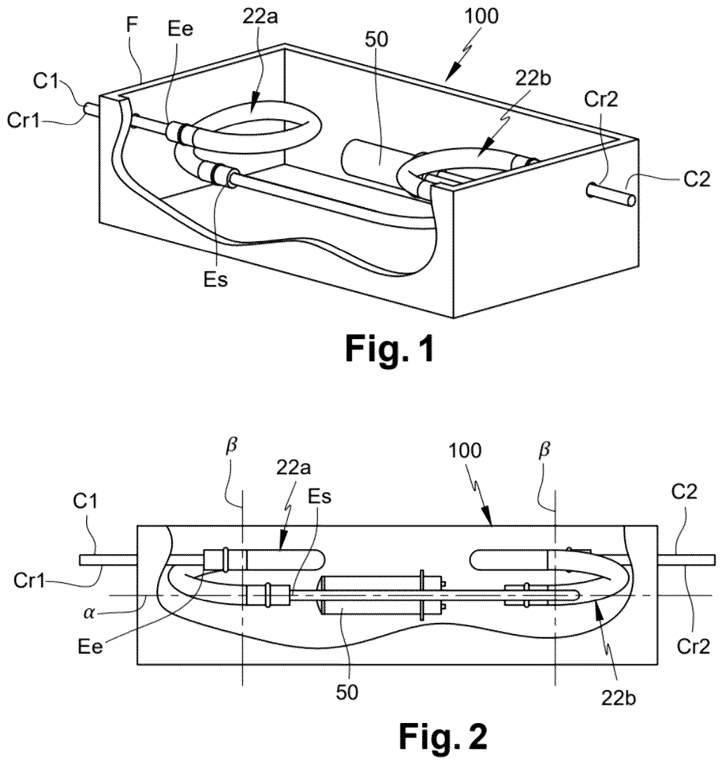

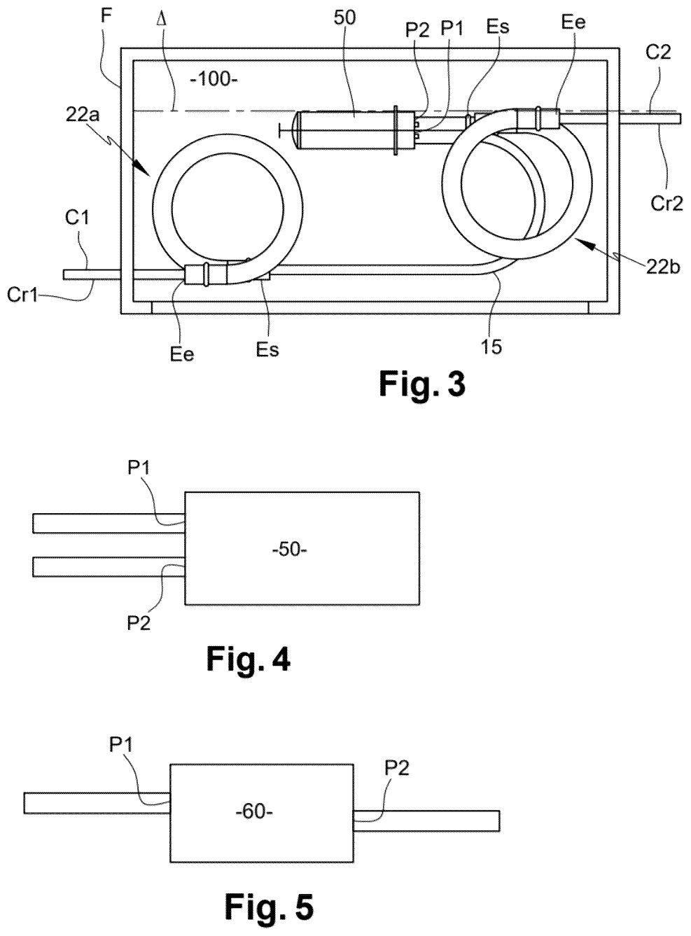

A first example of a connection assembly 100 according to the invention is represented in FIG. 1, which gives a perspective view of it. With the same conventions as FIG. 1, FIG. 2 gives a side view of it and FIG. 3 a view of it from above.

The connection assembly 100 enables connection of two superconductive cables C1, C2 in such a manner as to produce a transmission link. Each superconductive cable C1, C2 comprises a cable core surrounded by a cryogenic envelope Cr1, Cr2. The transmission link enables in particular communication of information carried by the signal transmitted by the cables C1, C2 that constitute it. The signal transmitted by the cables C1, C2 is in particular an electrical current. The superconductive cables are in particular connected in series.

A jointing device 50 enables the superconductive cables C1, C2 to be joined together. The jointing device 50 comprises two connection ports P1, P2. A first connection port P1 receives the cable core of a first superconductive cable C1; a second connection port P2 receives the cable core of a second superconductive cable C2.

In particular, in the jointing device 50 the cable cores of the superconductive cables C1, C2, in particular the superconducting parts, are electrically interconnected. In particular, the jointing device enables the cryogenic envelopes of the superconductive cables C1, C2 to be joined together for continuous circulation of the cryogenic fluid.

The connection assembly comprises two compensation devices 22a, 22b that absorb the variations in length of the cable cores caused by a temperature variation for passage to the superconductive state. Each compensation device 22a, 22b comprises an inlet end Ee configured to receive the cable core and an outlet end Es connected to the respective connection port P1, P2 to deliver the cable core to the jointing device 50.

The shortening linked to the cooling for passage to the superconductive state of the first cable C1 and the second cable C2 is therefore managed in the immediate proximity of the jointing device 50. Providing the jointing device 50 and the compensation devices 22a, 22b in a single assembly 100 enables their integration in a single space, which facilitates their integration in a superconductive cable system.

In the first example of a connection assembly 100 the connection ports P1, P2 of the jointing device 50 are situated at the same end of the jointing device 50. FIG. 4 represents diagrammatically the compensation device 50 in which the cable cores of the cables C1, C2 are connected to the connection ports P1, P2.

In particular, respective ends of the cable cores come to be side by side in the jointing device 50 to be joined in such a manner as to produce an electrical connection. The jointing device 50 may comprise a cryogenic envelope that enables cooling of the ends of the cable cores for a superconductive state. The cryogenic envelope of the jointing device 50 is in particular connected to a cryogenic envelope of each compensation device 22a, 22b via the connection ports P1 and P2 in such a manner as to achieve continuity of the cooling fluid.

However, the jointing device may have a different configuration. FIG. 5 represents diagrammatically another jointing device 60 in which the cable cores of the cables C1, C2 are connected to the connection ports P1, P2. The FIG. 5 jointing device 60 is identical to that depicted in FIG. 4 except that the connection ports P1, P2 of the jointing device 60 are situated at opposite ends of the jointing device 60.

In particular, a longitudinal direction of the jointing device 50, 60 is a direction in which the cable cores extend in the jointing device from one end of the jointing device 50, 60.

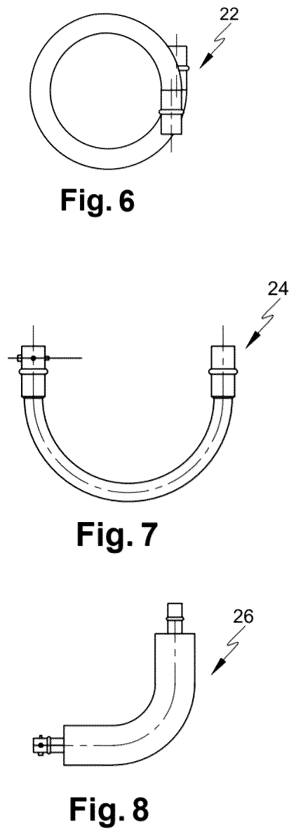

In particular, the compensation device 22a, 22b comprises an interior tube and an exterior tube that are coaxial and trace out a 360° curvature. The compensation device 22a, 22b is depicted in FIG. 6 for example.

However, the compensation device may utilize a different angle, greater than or equal to 90°. The device may utilize an angle of 180° as depicted in FIG. 7 for example or an angle of 90° as depicted in FIG. 8 for example. In particular, the compensation device is as described in the published patent application US 2019/0260194 A1.

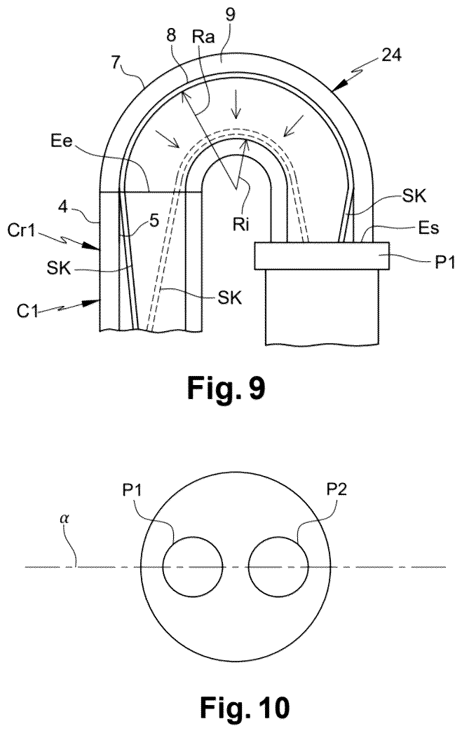

FIG. 9 represents one example of a compensation device 24 utilizing a 180° curvature. The compensation device 24 comprises an interior tube 8 and an exterior tube 7 that are coaxial. As known in itself, vacuum insulation is provided between the interior tube 8 and the exterior tube 7. The interior tube 8 receives the core SK of the superconductive cable. A cooling fluid circulates in the interior tube 8 to cool the core SK to a cooling temperature for the superconductive state.

The dimensions of the interior tube 8 and the exterior tube 7 are configured so that at ambient temperature the cable core SK is in the proximity of a portion of the internal wall of the interior tube 8 having the highest radius of curvature Ra and at cooling temperature the cable core SK is in the proximity of a portion of the internal wall of the interior tube Ri having the lowest radius of curvature. In particular, the inside diameter of the interior tube 8 is sufficiently large to enable this movement of the cable core SK.

The compensation device 24 may comprise a rectilinear part at one end of the curvature, like the right-hand end in FIG. 9 for example. The end of the rectilinear part then forms the end of the compensation device, in particular the outlet end Es. Alternatively, one end of the curvature of the compensation device 24 may come directly against the counterpart (superconductive cable C1 or connection port P1), such as for example the left-hand end in FIG. 9. The end of the curvature then forms the end of the compensation device, in particular the inlet end Ee.

In particular, the angle of the curvature is the angle traced out by the radius of curvature from the start of the curvature to the end of the curvature.

In particular, at one of their ends the tubes 7, 8 are connected to the cryogenic envelope Cr1 of the cable C1. In particular, the interior tube 8 is rigidly fastened to an interior tube 5 of the cryogenic envelope Cr1 of the cable C1 and the exterior tube 7 is rigidly fastened to an exterior tube 4 of the cryogenic envelope Cr1 of the cable C1. In a similar manner, at the other end the tubes 7, 8 may be connected to a cryogenic envelope of the jointing device.

Referring again to FIGS. 1 to 3, in the connection assembly 100 the curvatures are in particular accommodated in a space delimited by a side of the jointing device 50, in particular a longitudinal side of the jointing device 50. The space is in particular delimited by a plane tangential to the longitudinal side of the jointing device 50, indicated in FIG. 3 by a straight line segment Δ. Thanks to this arrangement the overall size of the connection assembly is limited, in particular in a direction perpendicular to the plane tangential to the side of the jointing device 50.

The curvatures of the compensation devices 22a, 22b are in particular such that their axes β are parallel to one another. In particular, the axis of a curvature corresponds to the straight line segment containing the centre of the radius of curvature around which the curvature extends. The overall size of the compensation devices 22a, 22b is therefore reduced.

In particular, the curvatures of the compensation devices 22a, 22b are situated face-to-face in the longitudinal direction of the jointing device 50, which enables further limitation of the overall size of the connection assembly 100.

In particular, the first compensation device 22a has a 360° curvature and its outlet end Es is oriented toward the same side as the first connection port P1 to which the core of the first cable C1 is connected. The connection assembly 100 comprises a U-shape compensation element 15 that enables connection of the outlet end Es of the first connection device 22a to the first connection port P1. The compensation element 15 may also comprise a rectilinear part between the outlet end Es and the U-shape portion. This rectilinear part makes it possible in particular to be sure that the U-shape portion is situated at a position in the longitudinal direction a that enables connection to the first connection port P1. The compensation device 15 is particularly advantageous in a superconductive cable installation in which the superconductive cables C1, C2 arrive in a jointing pit F from two opposite sides of the pit F. The compensation element 15 comprises in particular a cryogenic envelope connected to the cryogenic envelopes of the first compensation device 22a and the jointing device 50, the cryogenic envelope of the compensation element 15 receiving the core of the first cable C1.

FIG. 10 represents a diagrammatic view of the compensation device 50 in cross section, that is to say in particular in a plane perpendicular to the longitudinal direction of the compensation device 50. A central transverse plane is in particular a plane comprising a longitudinal direction of the compensation device 50 and dividing a connection port P1, P2 into two equal parts. The central transverse plane common to the two connection ports P1, P2 is in particular represented by the straight line segment α. In particular, during installation of the connection assembly 100 the jointing device 50 is mounted so that the central transverse plane α is horizontal. This facilitates the operations of mounting the cable cores in the connection ports P1, P2 and their mutual connection in the jointing device 50.

In particular, the axes of the curvatures of the compensation devices 22a, 22b are perpendicular to the central transverse plane α common to the connection ports P1, P2 of the jointing device 50. In particular, having their axes perpendicular to the central transverse plane a common to the two connection ports P1, P2, the curvatures of the compensation devices 22a, 22b extend mainly horizontally and have a limited overall size in the vertical direction. This arrangement is particularly suitable when the connection assembly 100 is installed in a jointing pit F the dimensions of which are more restricted in depth than in width. The connection assembly 100 is preferably arranged so that the longitudinal direction of the jointing device 50 is parallel to the direction in which the cables C1, C2 arrive.

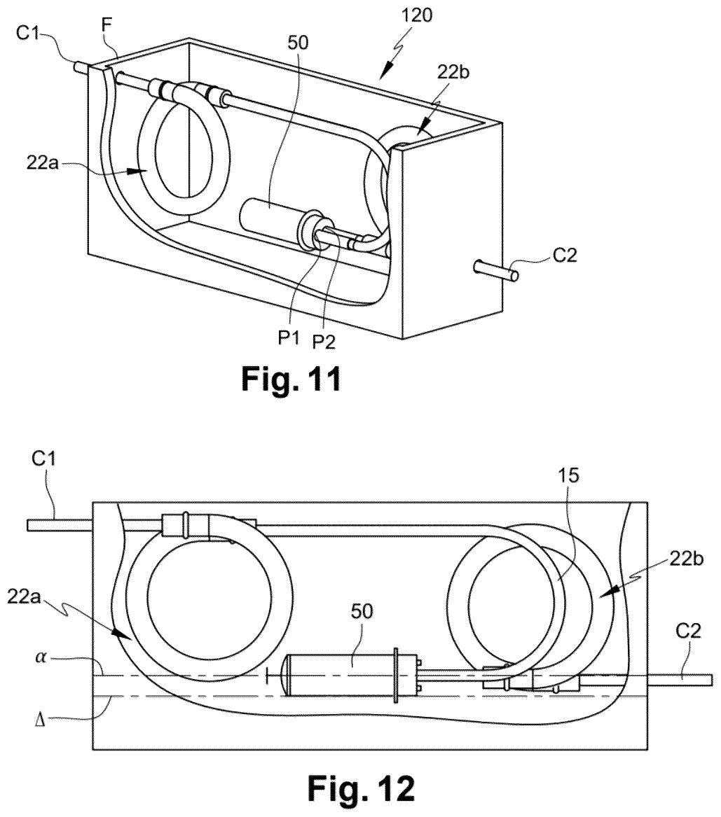

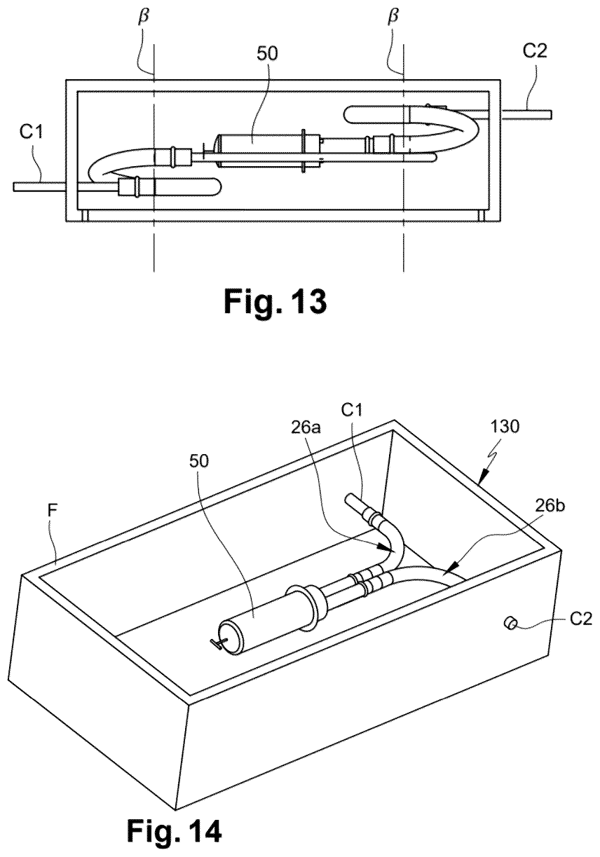

FIG. 11 depicts a perspective view of a second example 120 of a connection assembly. With the same conventions as FIG. 11, FIG. 12 shows a view of it from the side and FIG. 13 a view of it from above.

The second example 120 of a connection assembly is identical to the first example 110 except that the curvatures of the compensation devices 22a, 22b are on respective opposite sides of a median plane of the jointing device 50 and the axes β of the curvatures are parallel to the central transverse plane a common to the connection ports P1, P2 of the jointing device 50. In particular, having their axes parallel to the central transverse plane a common to the two connection ports P1, P2, the curvatures of the compensation devices 22a, 22b extend mainly vertically and have a limited overall size in the horizontal direction. This arrangement is particularly suitable when the connection assembly 120 is installed in a jointing pit F the dimensions of which are more restricted in width than in depth. The connection assembly 120 is preferably arranged so that the longitudinal direction of the jointing device 50 is parallel to the direction in which the cables C1, C2 arrive.

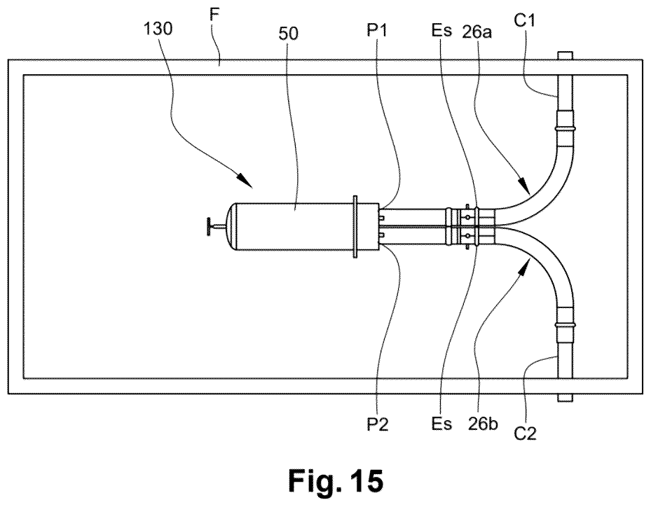

FIG. 14 depicts a perspective view of a third example 130 of a connection assembly. With the same conventions as FIG. 14, FIG. 15 gives a view of it from above. The third example 130 of the connection assembly is identical to the first example 100 except that it comprises two compensation devices 26a, 26b utilizing an angle of 90°. In particular the curvatures of the compensation devices 26a, 26b are situated substantially face-to-face in a direction perpendicular to the longitudinal direction of the jointing device 50.

This arrangement is particularly suitable when the connection assembly 130 is installed in a jointing pit F when the superconductive cables C1, C2 arrive in the pit F at opposite sides of the pit F and the jointing pit has a less restricted overall size in a direction perpendicular to the direction in which the cables C1, C2 arrive. The connection assembly 130 is preferably arranged so that the longitudinal direction of the jointing device 50 is perpendicular to the direction in which the cables C1, C2 arrive.

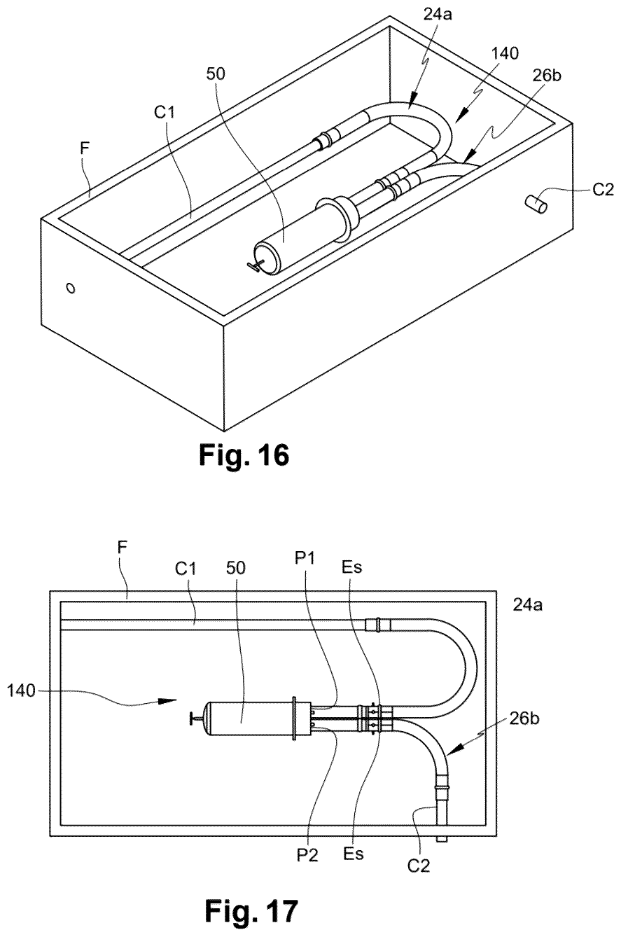

FIG. 16 depicts a perspective view of a fourth example 140 of a connection assembly. With the same conventions as FIG. 16, FIG. 17 gives a view of it from above. The fourth example 140 of a connection assembly is identical to the third example 130 except that it comprises a first compensation device 24a utilizing an angle of 180° and a second compensation device 26b utilizing an angle of 90°.

This arrangement is particularly suitable when the connection assembly 140 is installed in a jointing pit F when the superconductive cables C1, C2 arrive at contiguous sides of the pit F, in particular when the cables arrive with a non-negligible angle between them, in particular an angle of 90°. The connection assembly 140 is preferably arranged so that the longitudinal direction of the jointing device 50 is parallel to the direction of arrival of the first cable C1 that is connected to the first compensation device 24a.

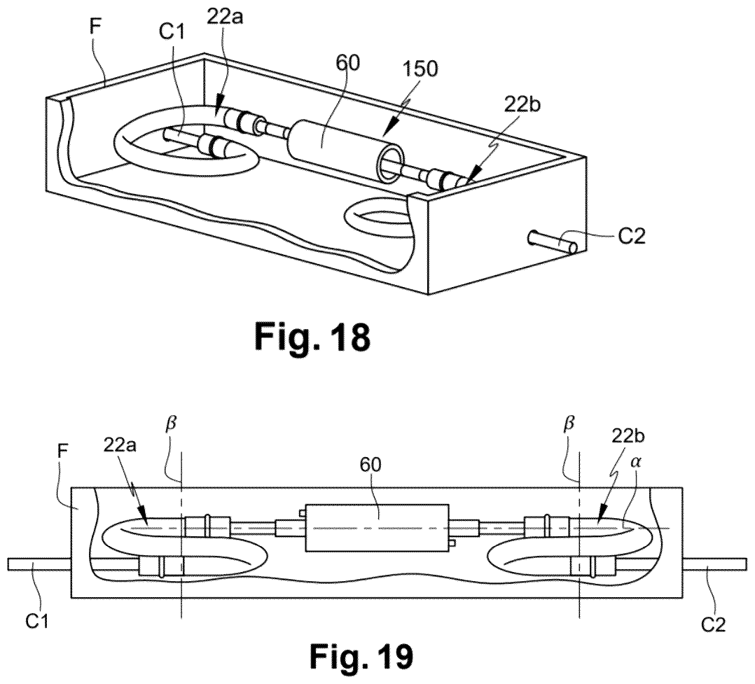

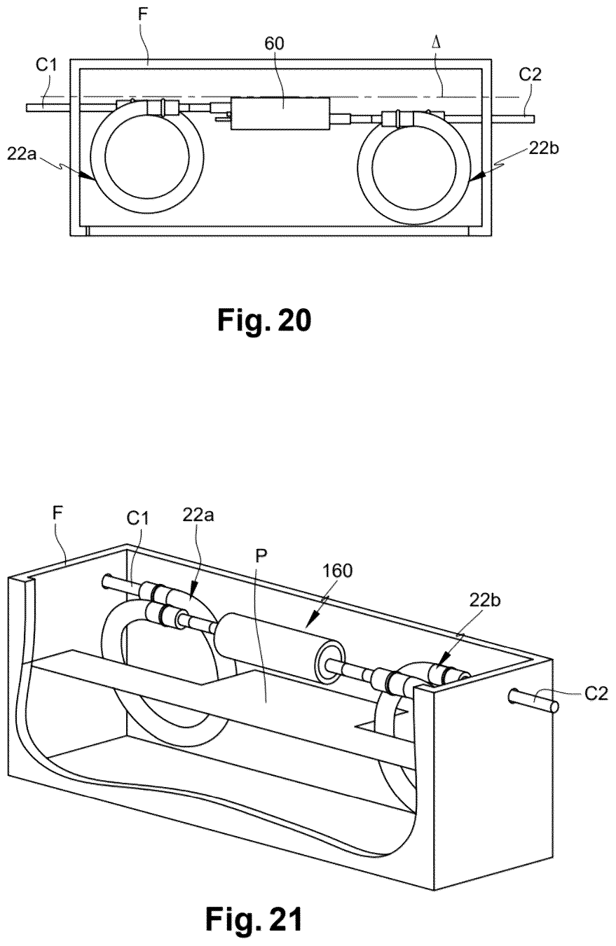

A fifth example of a connection assembly 150 according to the invention is represented in FIG. 18, which gives a perspective view of it. With the same conventions as FIG. 18, FIG. 19 gives a side view of it and FIG. 20 a view of it from above.

The connection assembly 150 enables connection of two superconductive cables C1, C2 in such a manner as to produce a transmission link, as already described with reference to the first example 100. The cables C1, C2 are identical to those described with reference to the first example 100.

In this fifth example of a connection assembly 150 the connection ports P1, P2 of the jointing device 60 are situated at opposite ends of the jointing device. The jointing device 60 is in particular as described above with reference to FIG. 5.

The connection assembly 150 comprises two compensation devices 22a, 22b that absorb the variations in length of the cable cores caused by a variation in temperature for passage to the superconductive state. In particular, each of the compensation devices 22a, 22b utilizes an angle of 360°. In particular, the compensation devices 22a, 22b are as described above with reference to FIG. 6. The compensation devices may nevertheless utilize different angles, for example as described in the first example of a connection assembly 100.

The curvatures of the compensation devices 22a, 22b are in particular accommodated in a space delimited by a side of the jointing device 60, in particular a longitudinal side of the jointing device 60. The space is in particular delimited by a plane tangential to the longitudinal side of the jointing device 60 identified in FIG. 20 by the straight line segment Δ. Thanks to this arrangement the overall size of the connection assembly is limited, in particular in a direction perpendicular to the plane tangential to the side of the jointing device 60.

In particular, the curvatures of the compensation devices 22a, 22b are situated face-to-face in the longitudinal direction of the jointing device 60, which enables further limitation of the overall size of the connection assembly 150.

In particular, the axes of the curvatures of the compensation devices 22a, 22b are perpendicular to the central transverse plane a (already described with reference to FIG. 10) common to the connection ports P1, P2 of the jointing device 60. The connection assembly 150 is preferably arranged so that the longitudinal direction of the jointing device 60 is parallel to the direction in which the cables C1, C2 arrive.

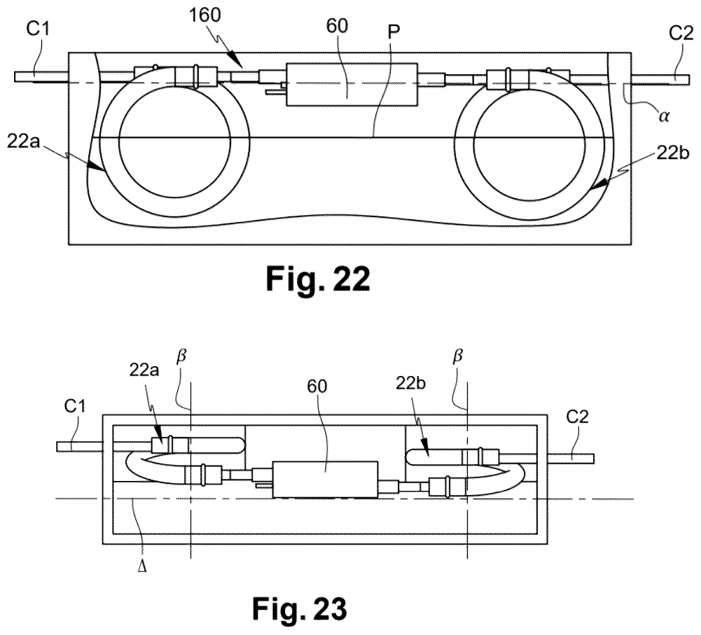

FIG. 21 depicts a perspective view of a sixth example 160 of a connection assembly. With the same conventions as FIG. 21, FIG. 22 gives a side view of it and FIG. 23 a view of it from above.

The sixth example 160 of a connection assembly is identical to the fifth example 150 except that the axes β of the curvatures of the compensation devices 22a, 22b are parallel to the transverse plane a common to the connection ports P1, P2 of the jointing device 60. In particular, having their axes parallel to the central transverse plane a common to the two connection ports P1, P2, the curvatures of the compensation devices 22a, 22b extend mainly vertically and have a limited overall size horizontally. The connection assembly 160 is preferably arranged so that the longitudinal direction of the jointing device 60 is parallel to the direction in which the cables C1, C2 arrive. A platform P may be mounted in the pit F receiving the connection assembly 160 to enable operatives to access the jointing device 60 to make the joint between the cables C1, C2.

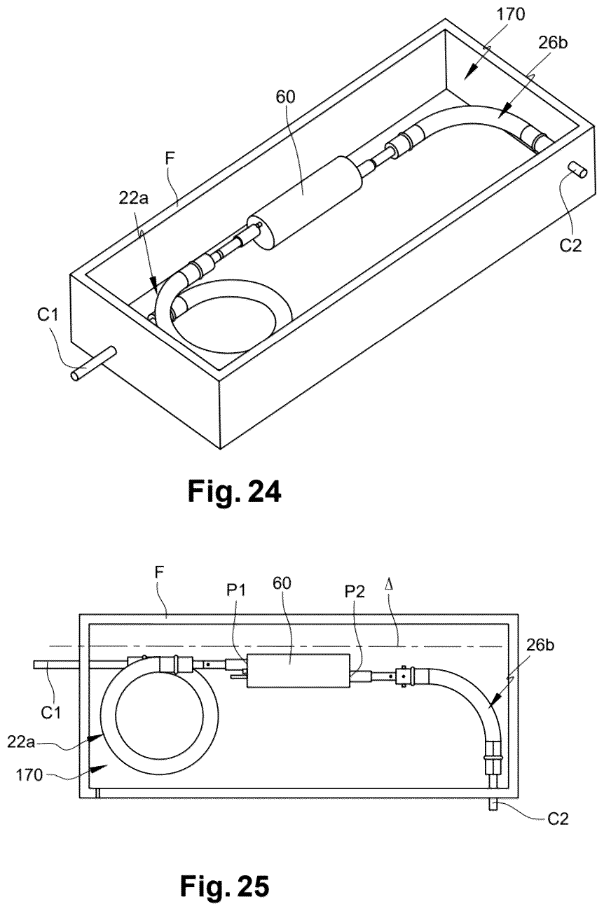

FIG. 24 depicts a perspective view of a seventh example 170 of a connection assembly. With the same conventions as FIG. 24, FIG. 25 gives a view of it from above. The seventh example 140 of a connection assembly is identical to the fifth example 150 except that it comprises a first compensation device 22a utilizing an angle of 360° and a second compensation device 26b utilizing an angle of 90°.

This arrangement is particularly suitable when the connection assembly 170 is installed in a jointing pit F in which the superconductive cables C1, C2 arrive at contiguous sides of the pit F, in particular when the cables arrive with a non- negligible angle between them, in particular an angle of 90°. The connection assembly 170 is preferably arranged so that the longitudinal direction of the jointing device 60 is parallel to the direction in which the first cable C1 that is connected to the first compensation device 22a arrives.

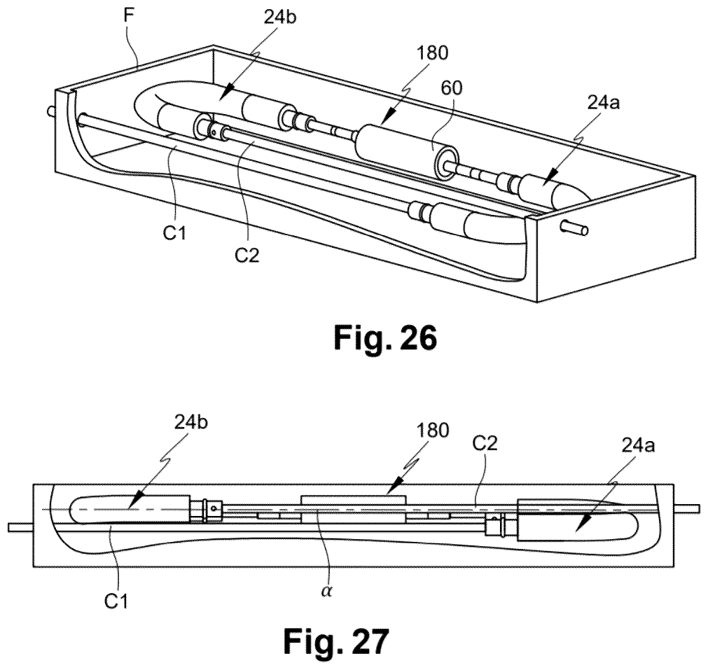

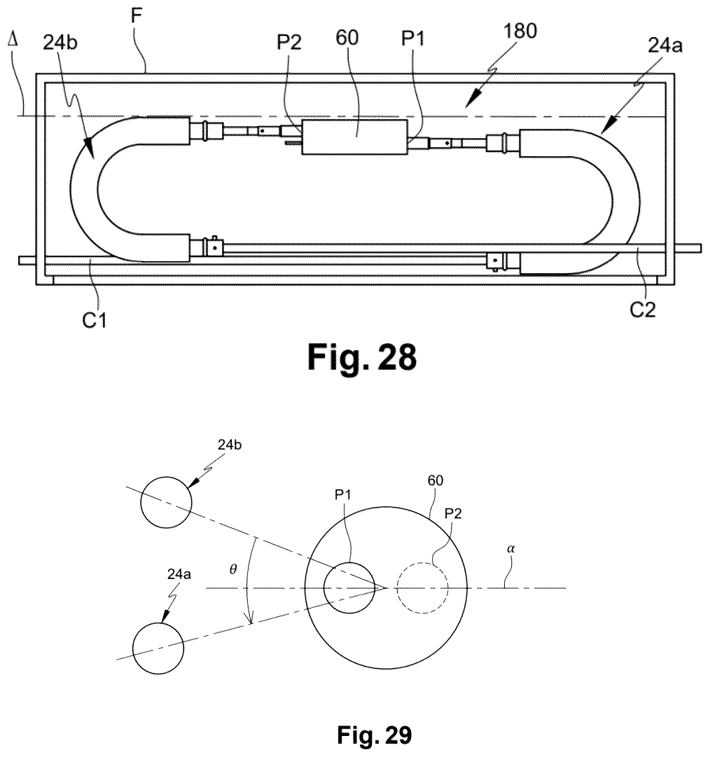

FIG. 26 depicts a perspective view of an eighth example 180 of a connection assembly. With the same conventions as FIG. 26, FIG. 27 gives a side view of it and FIG. 28 a view of it from above. FIG. 29 represents a schematic view in section of the connection assembly 180.

The eighth example 180 of a connection assembly is identical to the fifth example 150 except that it comprises a first compensation device 24a utilizing an angle of 180° and a second compensation device 24b utilizing an angle of 180° that are face-to-face in the longitudinal direction of the jointing device 60. The curvatures of the compensation devices 24a, 24b have a small angular offset ⊖ between them in such a manner as to allow to pass the cables C1, C2 connected to the compensation devices 24a, 24b. In particular, the angular offset ⊖ is one radian measured relative to the longitudinal direction of the jointing device 60. The overall size of the connection assembly 180 is therefore limited while enabling connection of the cables C1, C2 to their respective compensation device 24a, 24b. In particular, the angular offset ⊖ is a function of the diameter of the cables C1, C2 or of the diameter of the tubes of the compensation device. In particular it is between a few degrees, for example 1°, and 45° or even between 5° and 20°.

In particular, as depicted in FIG. 29, the common central transverse plane α of the connection ports P1, P2 of the jointing device 60 crosses the angular offset ⊖ between the compensation devices 24a, 24b. Thus, when the connection assembly 180 is mounted in the pit F so that the common transverse plane a is horizontal, the curvatures of the compensation devices 24a, 24b extend mainly horizontally and have a limited overall size vertically.

This arrangement is particularly suitable when the connection assembly 180 is installed in a jointing pit F whose dimensions are more restricted in depth than in width. This arrangement is further particularly suitable when the connection assembly 180 is installed in a jointing pit F in which the superconductive cables C1, C2 arrive at opposite sides of the pit F. The connection assembly 100 is preferably arranged so that the longitudinal direction of the jointing device 60 is parallel to the direction in which the cables C1, C2 arrive.

In particular, the connection assembly according to the invention is modular. The jointing devices 50, 60 can be combined with any two of the compensation devices 22, 24, 26 utilizing any angle greater than or equal to 90°, in particular as described above. Thus, the connection assembly best adapts to the space available in the jointing pit F and/or to the directions in which the cables C1, C2 arrive in the jointing pit F.

In particular, the jointing pit F defines a space in which the superconductive cables C1, C2 are joined, in particular by operatives. The jointing pit F may be delimited by walls, in particular laterally, at its base or at its top. The cables C1, C2 are in particular routed in ducts that open into the jointing pit F.

In one embodiment of the examples described above the cables C1, C2 have a first end connected to the respective compensation device of the connection assembly 100, 120, 130, 140, 150, 160, 170, 180 and a second end connected to another compensation device, in particular forming part of another connection assembly or being connected to a transmission link termination. Thus, for each cable C1, C2, the shortening due to cooling is managed at each of the ends of the cables. In doing so, the length to be managed by each compensation device is half that in an example where, for each cable, a single compensation device would manage the shortening at one end of the cable. By managing the compensation at each end of the cables C1, C2 the compensation devices are relatively smaller.

A superconductive cable installation can therefore comprise a plurality of the connection assemblies described above for connecting in series a plurality of cables of a transmission link. A cable connected to two successive connection assemblies then has its first end connected to a compensation device of the first connection assembly and its second end connected to a compensation device of the second connection assembly.

The connection assembly examples 100, 120, 130, 140, 150, 160, 170, 180 described above comprise two compensation devices. However, a different connection assembly could comprise only one compensation device. In particular, the compensation device is connected to the first connection port P1. The second cable C2 is connected, in particular directly, to the second connection port P2. In particular, such a connection assembly is moreover similar to the connection assembly examples described above, in particular where the connection device and the jointing device are concerned. The axis of the curvature of the compensation device may be parallel or perpendicular to the common transverse plane a of the connection ports P1, P2 of the jointing device 50, 60.

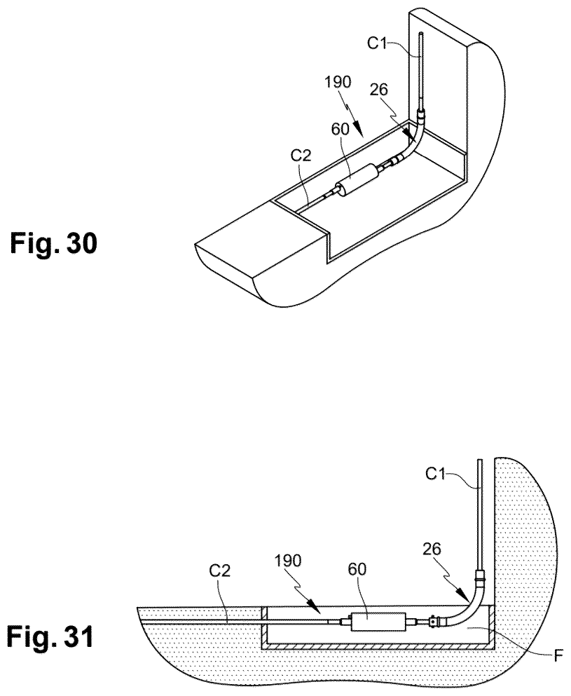

FIGS. 30 and 31 depict an example 190 of such a connection assembly. The connection assembly 190 comprises a compensation device 26 utilizing an angle of 90°, as described above with reference to FIG. 8, which is connected to one end of a jointing device 60 as described above with reference to FIG. 5. A cable C2 is connected to the opposite end of the jointing device 60. The assembly 190 is in particular received in a pit F. This example 190 of a connection assembly is particularly suitable for enabling a cable C1 descending from a height, for example from a bridge, to be connected to a cable C2, for example on the ground.

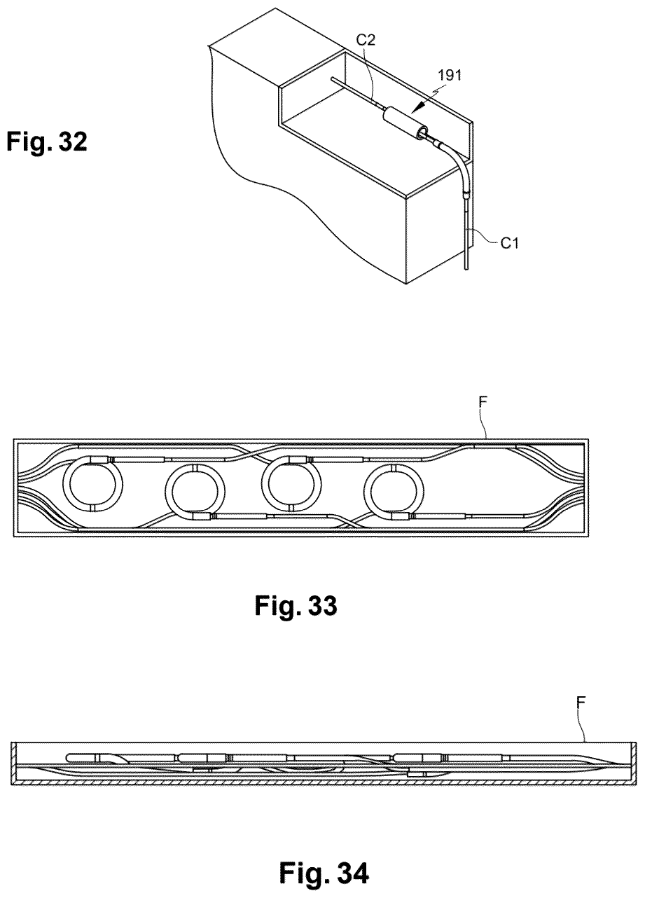

FIG. 32 depicts an example 191 of a connection assembly identical to the example 190 described above except for the orientation in which it is installed in the system of superconductive cables C1, C2. In fact, this example 191 of a connection assembly is suitable for enabling a cable C1 extending upwards from a low height, for example the ground, to a greater height, for example a bridge, to be connected to a cable C2 located at the greater height.

A jointing pit may comprise a plurality of connection assemblies as described above. This is in particular the case when a plurality of pairs of cables arrive in the pit F to be connected by respective connection assemblies. For example, for a direct current system one cable is at the positive potential and another is at the negative potential. The two cables arrive in the pit F to be joined to their counterparts via two connection assemblies. In another example comprising a three-phase alternating current system each phase is transmitted by a respective cable. The three phases arrive in the pit F to be connected to their counterparts via three connection assemblies.

The curvatures of the compensation devices preferably have axes parallel to one another to limit the overall size in the jointing pit F, as depicted in the figures for example.

Examples of installations comprising a plurality of connection assemblies are described with reference to FIGS. 33 to 40.

To limit the overall size the jointing devices are preferably all aligned in the same longitudinal direction. In particular, the common transverse planes a of the jointing devices are parallel to one another.

The axes of the curvatures of the compensation devices are preferably parallel to the common transverse plane a of the connection ports P1, P2 of the connection devices.

The curvatures of at least some of the compensation devices are preferably face-to-face in the longitudinal direction common to the jointing devices, as depicted in FIGS. 33 to 36 for example.

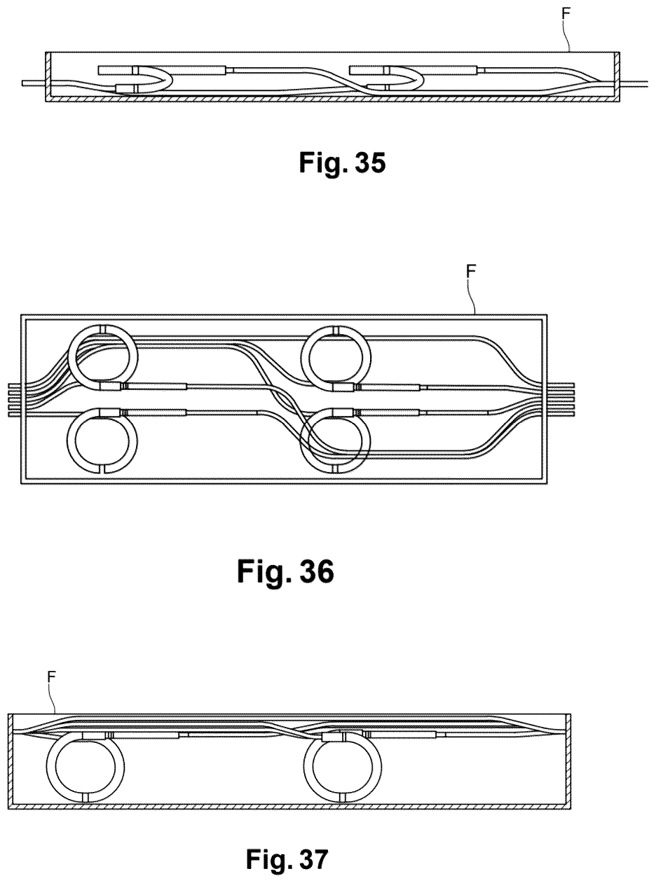

The curvatures of at least some of the compensation devices are preferably face-to-face in a direction perpendicular to the longitudinal direction common to the jointing devices, as depicted in FIGS. 35 and 36 for example.

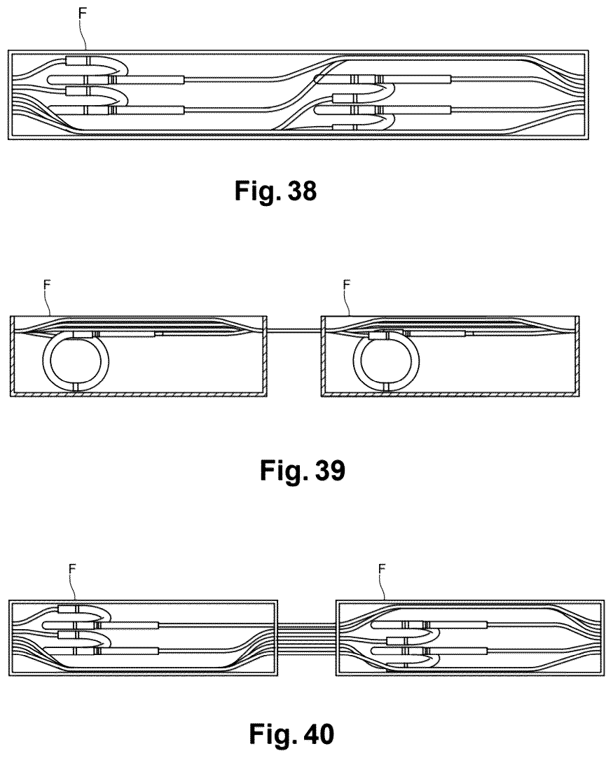

The curvatures of at least some of the compensation devices are preferably face-to-face so that their axes coincide, as depicted in FIGS. 37 and 38 for example.

The various configurations of the connection assemblies or the superconductive cable installations are aimed in particular at reducing or limiting the length of the jointing pit F.

As depicted in FIGS. 39, 40 for example, the superconductive cable installation comprising a plurality of connection assemblies may comprise at least two jointing pits F in which the superconductive cables arrive. Each jointing pit F comprises respective connection assemblies. Each connection assembly connects a respective pair of the superconductive cables arriving at the pit F, one of the cables of the pair crossing the other jointing pit. Such an installation is particularly suitable when the number of superconductive cables is too high to connect them in the same space.

FIGS. 33 to 40 represent installations in which jointing pits F comprise connection assemblies with only one compensation device. However, the examples represented could comprise connection assemblies comprising two compensation devices, as described above. Furthermore, these figures represent installations comprising compensation devices utilizing an angle of 360°, but the examples represented could comprise other compensation devices, in particular as described above. Also, in these FIGS. 33 to 40 the connection devices have their connection ports situated at their opposite ends. However, the jointing devices could be different and in particular comprise connection ports situated at the same end of the jointing device, in particular as described above.

1. A superconductive cable installation comprising at least one jointing pit in which arrive superconductive cables, each superconductive cable comprising a cable core surrounded by a cryogenic envelope and at least one connection assembly situated in said jointing pit in such a manner as to connect two of said superconductive cables to produce a transmission link, said connection assembly comprising:
a jointing device comprising two connection ports, each connection port being configured to receive the cable core of a respective one of the two superconductive cables, and
two compensation devices configured to absorb a variation in length of the cable core of a respective one of said superconductive cables caused by a variation in temperature for passage to the superconductive state,
each compensation device comprising an inlet end configured to receive the cable core and an outlet end connected to a respective one of said connection ports in such a manner as to deliver the cable core to the jointing device.

2. The superconductive cable installation according to claim 1 in which the connection ports of the jointing device are situated at opposite ends of the jointing device.

3. The superconductive cable installation according to claim 1 in which the connection ports of the jointing device are situated at the same end of the jointing device.

4. The superconductive cable installation according to claim 1 in which each compensation device includes an interior tube and an exterior tube that are coaxial and between which vacuum insulation is provided, the interior tube being configured to receive the core of the respective superconductive cable and a cooling fluid intended to cool said core to a cooling temperature for a superconductive state;
said interior and exterior tubes utilizing at least one curvature by an angle greater than or equal to 90° and the dimensions of the interior and exterior tubes being configured so that, in said curvature:
at ambient temperature the cable core is in the proximity of a portion of the internal wall of the interior tube having the highest radius of curvature, and
at cooling temperature the cable core is in the proximity of a portion of the internal wall of the interior tube having a lowest radius of curvature.

5. The superconductive cable installation according to claim 4 in which the curvatures of the compensation devices are accommodated in a space delimited by a side of the jointing device and/or arranged so that their axes are parallel to one another.

6. The superconductive cable installation according to claim 4 in which the curvatures are situated substantially face-to-face in a longitudinal direction of the jointing device.

7. The superconductive cable installation according to claim 4 in which the axes of the curvatures are perpendicular or parallel to a central transverse plane common to the connection ports of the jointing device.

8. The superconductive cable installation according to claim 4 in which
the curvatures of the compensation devices are on respective opposite sides of a median plane of the jointing device, and
the axes of the curvatures are parallel to a transverse plane common to the connection ports of the jointing device.

9. The superconductive cable installation according to claim 4 in which one of said compensation devices utilizes a curvature of 360°,
this compensation device having an outlet end oriented toward the same side as the corresponding connection port of the jointing device,
said outlet end of said compensation device being connected to the respective port via a compensation element of U-shape.

10. The superconductive cable installation according to claim 2 in which the curvatures of the compensation devices utilize angles of 180° and have an angular offset between them in such a manner as to allow to pass the cables connected to the compensation devices.

11. The superconductive cable installation according to claim 1 comprising a plurality of connection assemblies situated in said jointing pit in such a manner as to connect a respective pair of said superconductive cables.

12. The superconductive cable installation according to claim 11 in which the jointing devices are aligned in the same longitudinal direction and the curvatures are face-to-face in said longitudinal direction or in a direction perpendicular to said longitudinal direction.

13. The superconductive cable installation according to claim 1 comprising at least two jointing pits in which the superconductive cables arrive, each jointing pit comprising at least one connection assembly in such a manner as to connect a respective pair of said superconductive cables, one of the cables of the pair crossing the other jointing pit.

14. The superconductive cable installation according to claim 1 in which the superconductive cables connected to the at least one connection assembly comprise a first end connected to said connection assembly and a second end connected to a compensation device.

15. The superconductive cable installation according to claim 1 comprising a plurality of connection assemblies connecting in series a plurality of cables of a transmission link.
